(19) United States
(12) Patent Application Publication
(10) Pub. No.: US 2007/0296737 A1
(43) Pub. Date: Dec. 27, 2007

(54) Apparatus And Method For Displaying Image Data

(75) Inventors: Sang-joon Park, Suwon-si (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SANSUNG ELECTRONIC CO., LTD.

(21) Appl. No.: 10/585,309

(22) PCT Filed: Sep. 21, 2004
(86) PCT No.: PCT/KR04/02411

§ 371 Date: Mar. 19, 2007

(30) Foreign Application Priority Data
Jan. 6, 2004 (KR) 10-2004-0000590

(51) Int. Cl. G09G 5/00

(52) U.S. Cl. 345/634

(57) ABSTRACT

Disclosed are an apparatus and a method for displaying image data, wherein the apparatus includes a display unit displaying image data, a control unit dividing a plurality of image data by a desired number to form groups and display representative images of each group, and displaying images of a corresponding group when a representative image is selected; and an input unit receiving an input to navigate and select the displayed images.

### TECHNICAL FIELD

The present invention relates to an apparatus and a method for displaying image data and, more specifically, to an apparatus and a method for displaying image data wherein a user can more efficiently search and manage desired images among a plurality of thumb nail images using an image display apparatus.

### BACKGROUND ART

‘Thumb nail image’ has a meaning of ‘a thumb-nail sized picture’, wherein an original image having a large volume of data is represented as an image having a smaller amount data so as to enable the large volume of image data to be searched or managed at a high speed. For example, when a user generates a folder including various formats of image data using a window finder in the Windows XP operating system and clicks the right button of a mouse in the folder, a ‘View’ menu appears. At this time, when the user selects a ‘Preview’ menu in the ‘View’ menu, image files in the folder appear as small figures, whose image files also correspond to thumb nail images. The Windows XP generates a file ‘thumbs.db’ for managing such thumb nail images.

FIG. 1 is a view illustrating a User Interface for providing a user with a plurality of image files in accordance with a conventional method.

A user interface 100 includes a display area 106 that displays various types of image files to the user, a page information area 102 that indicates order information of an image file being displayed currently, and a display control area 104 used to view other image files which are not displayed in the display area 106. The ‘page’ means each of groups when image files listed continuously are divided by a desired number. Also, the user interface can be provided by equipments such as a personal computer, a DVD player, a digital camera and a portable terminal, which can display image files.

FIG. 1 illustrates an example of a user interface that is used to display 300 files stored in a display unit or a separate storage unit. Here, when it is assumed that the display area 106 can display 6 images at maximum, a total 50 pages are needed by grouping the 6 images as one group, and an area showing such information is the page information area 102. That is, ‘50’ in ‘1/50’ indicates the total number of pages for displaying the total image files, and ‘1’ indicates a current page number relative to the total number of pages. Accordingly, the user interface 100 shown in FIG. 1 displays pictures 1 to 6 included in the first page among the total 300 image files. On the other hand, the display control area 104 includes a menu used to move to the next or previous page so that the user can see other files which are not currently displayed. That is, as shown in FIG. 1, when the user selects an item ‘next’, the second page appears displaying pictures 7 to 12. At this time, a value of the page information area 102 is also changed. Then, when the user selects the item ‘next’ of the user interface 110, a user interface 120 appears displaying images 13 to 18 of the third page.

### DISCLOSURE OF INVENTION

### Technical Problem

However, in the conventional method as described above, when the user wishes to search for a specific image file or to see an image that was previously seen as from the image, it is inconvenient that the user has to search for the file sequentially starting from the first page. For example, the user can see the 300^{th} image file in FIG. 1 by moving from the first page to the 50^{th} page sequentially. That is, since there is no function with which the user can select a specific image among image files listed sequentially and see starting from the selected image, there is a problem that the user has to spend much time to see the specific image file as the number of image files increases.

### Technical Solution

The present invention is conceived in a bid to solve the problems described above. It is an objective of the present invention to propose a method for enabling a user to search for a desired image more rapidly by grouping a plurality of thumb nail images into a predetermined number and forming a desired data structure that shows entire files on a screen in a simple manner.

Consistent with an aspect of the present invention, there is provided a device for displaying image data, comprising a display unit for displaying said image data, a control unit for dividing a plurality of said image data by a desired number to form groups of images and display representative images of each group, and for displaying images of a corresponding group when a representative image is selected, and an input unit for receiving an input to navigate and select among said displayed images.

In an exemplary embodiment, said control unit divides images of a group including selected representative images by a desired number and regroups said divided images, and displays said representative images of said regrouped groups.

In an exemplary embodiment, said desired number represents the number of grouping of representative images inputted by a user or a predetermined number.

In an exemplary embodiment, said representative image is the first image generated or the last image generated among said grouped image data.

According to another aspect of the present invention, there is provided a method of displaying image data, comprising the steps of (a) dividing a plurality of image data by a desired number, (b) grouping said divided image data, (c) selecting a representative image of each group by desired reference, (d) displaying said representative images, and (e) displaying images of a corresponding group when said representative image is selected.

In an exemplary embodiment, the method further comprises the steps of (a) dividing said images of said corresponding group by said desired member and thereafter regrouping said divided images, and (b) displaying representative images of said regrouped groups.

In an exemplary embodiment, said desired number represents the number of grouping of representative images inputted by a user or a predetermined number.

In an exemplary embodiment, said representative image is the first image generated or the last image generated among said grouped images.

In an exemplary embodiment, said step of displaying images of said corresponding group includes using four direction key to navigate among said displayed images, and a function means to process one image among said displayed images.

In an exemplary embodiment, said function means include a button for selecting one image among said displayed images.

### DESCRIPTION OF DRAWINGS

The above and other features and advantages of the present invention will become more apparent to those of ordinary skill in the art by describing in detail preferred embodiments thereof with reference to the attached drawings in which:

FIG. 1 is a view illustrating a User Interface for providing a user with a plurality of image files in accordance with a conventional method;

FIG. 2 is a view illustrating a logical hierarchy structure of thumb nail images in accordance with the present invention;

FIGS. 3 to 6 are views illustrating user interfaces that provide a user with a plurality of image files in accordance with an exemplary embodiment of the present invention;

FIGS. 7 and 8 are views illustrating user interfaces in a personal computer environment using a mouse in accordance with an exemplary embodiment of the present invention;

FIGS. 9 and 10 are views illustrating user interfaces in a personal computer environment using a mouse in accordance with another exemplary embodiment of the present invention;

FIG. 11 is a view illustrating a user interface in a digital camera in accordance with an exemplary embodiment of the present invention;

FIG. 12 is a view illustrating a user interface in a DVD player in accordance with an exemplary embodiment of the present invention;

FIG. 13 is a view illustrating a data structure of a plurality of thumb nail images in accordance with an exemplary embodiment of the present invention;

FIG. 14 is a view illustrating thumb nail images displayed in the user interface in accordance with the data structure in FIG. 13; and

FIG. 15 is a flow chart for calculating a level depth and the number of pages in the lowest level in accordance with an exemplary embodiment of the present invention.

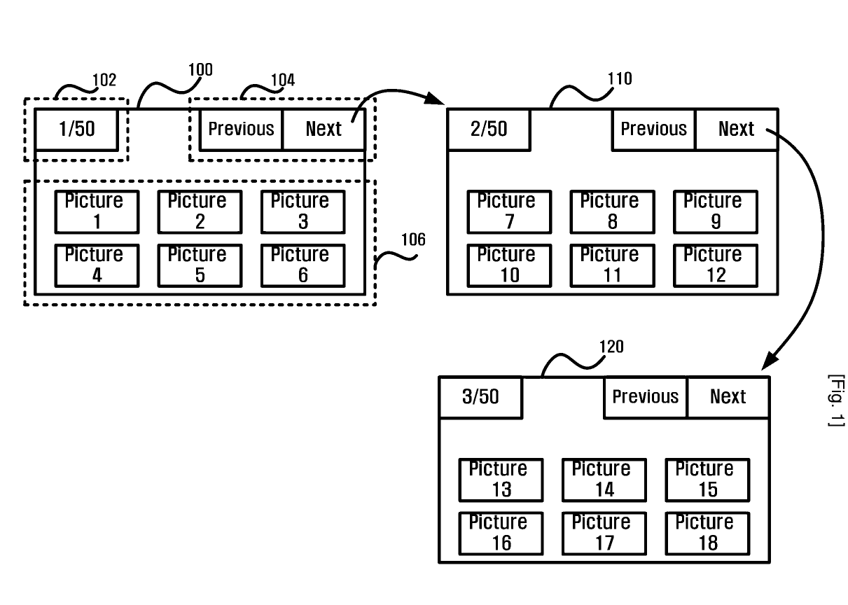

### MODE FOR INVENTION

Hereinafter, the present invention will be described with reference to 300 thumb nail images sequentially stored in a device which can display image data or a separate storage medium by way of an example. It is assumed that the device for displaying thumb nail images can display 6 images at maximum through a user interface. However, this is merely to explain the present invention more easily. And, while the number of the images displayed on a screen and the number of the stored thumb nail images depend on a device which provides the user interface or a storage medium which stores thumb nail images, the technical idea of the present invention can be applied without discrimination.

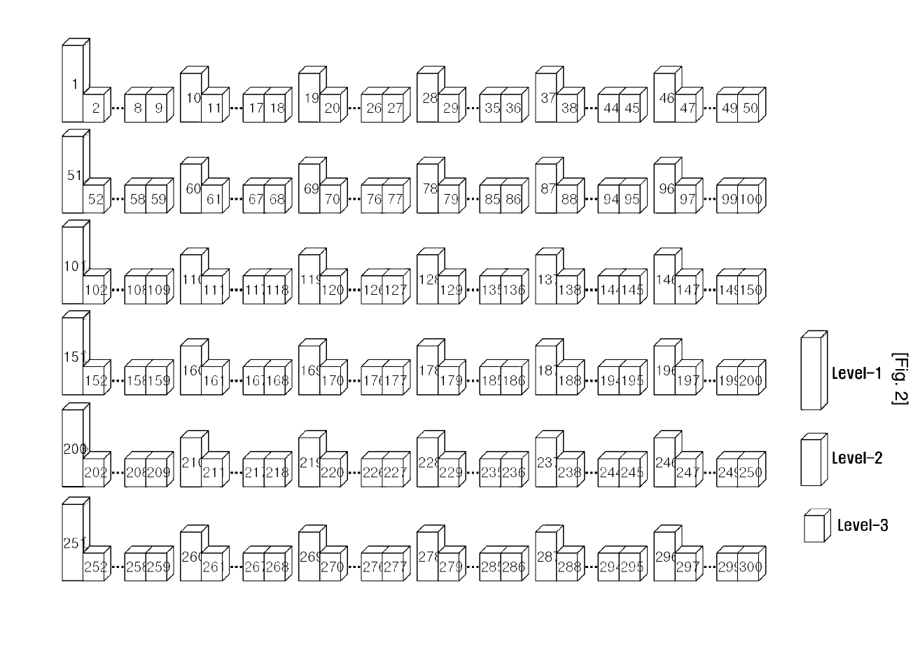

FIG. 2 is a view illustrating a logical hierarchy structure of thumb nail images in accordance with the present invention.

The present invention introduces a concept of ‘level’ in order to explain the logical hierarchy structure of thumb nail images. For example, when 6 images are to be displayed in a display area of the device that displays image data according to a user's selection or a predetermined value, the images can be sequentially divided into 6 groups, one group consisting of 50 images. At this time, representative thumb nail images of each group may be thumb nail images which lead the other thumb nail images included in each group. That is, when total 300 thumb nail images are sequentially divided into 6 groups, 1^{st}, 51^{st}, 101^{st}, 151^{st}, 200^{th} and 251^{st} thumb nail images can be the representative thumb nail images of each group. The 1^{st}, 51^{st}, 101^{st}, 151^{st}, 200^{th} and 251^{st} thumb nail images can be defined as thumb nail images included in a level-1.

For example, when 50 thumb nail images included in the first group of the level-1 are divided into 6 groups, 1^{st}, 10^{th}, 19^{th}, 28^{th}, 37^{th} and 46^{th} thumb nail images can be defined as thumb nail images included in a level-2.

Also, 9 thumb nail images included in the first group of the level-2 can be defined as thumb nail images included in a level-3, wherein since 6 images appear on one screen at maximum, the 9 thumb nail images appear on the total number of 2 pages. At this time, the level-1 is called the highest level, and the level-3 is called the lowest level.

Here, while the number of the level is 3, the number of the level in accordance with the present invention depends on the number of the thumb nail images which can be displayed. However, a method for discriminating the levels can be applied to the same method as described above.

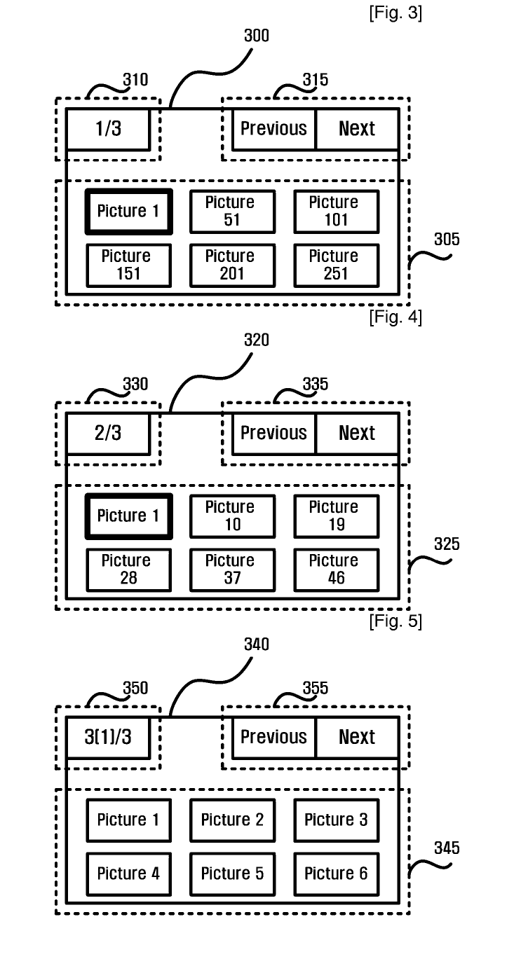

FIGS. 3 to 6 illustrate user interfaces that provide a user with a plurality of image files in accordance with an exemplary embodiment of the present invention.

User interfaces 300, 320, 340 and 360 include display areas 305, 325, 345 and 365 for displaying various formats of image files to be watched by the user, level information areas 310, 330, 350 and 370 for displaying level information on image files which are currently displayed, and page control areas 315, 325, 355 and 375 for moving a page at the lowest level. At this time, the ‘page’ means each of groups when image files listed continuously are divided by a desired number. Also, the user interface can be provided by equipments such as a personal computer, a DVD player, a digital camera and a portable terminal, which can display image files.

The display areas 305, 325, 345 and 365 shown in FIGS. 3 to 6 can display 6 thumb nail images at maximum, wherein thumb nail images displayed in FIG. 3 are thumb nail images included in the level-1 shown in FIG. 2. The level information area 310 displays ‘1/3’ which indicates a current level to the total level. That is, it means that while the total level is 3, a level of thumb nail images displayed currently is 1. Also, a thumb nail image which is activated among the 6 thumb nail images can be displayed as a highlight. In FIG. 3, ‘picture 1’ is activated. On the other hand, a function key or a function button to activate other thumb nail images or to select an activated thumb nail image can be attached to a device which provides the user interface shown in FIG. 3.

When the user selects ‘picture 1’ in FIG. 3, a user interface as in FIG. 4 appears. At this time, thumb nail images included in the level-2 shown in FIG. 2 are displayed in the display area 325. Also, ‘2/3’ appears in the level information area, which it indicates that the level of thumb nail images which are currently displayed is the level-2.

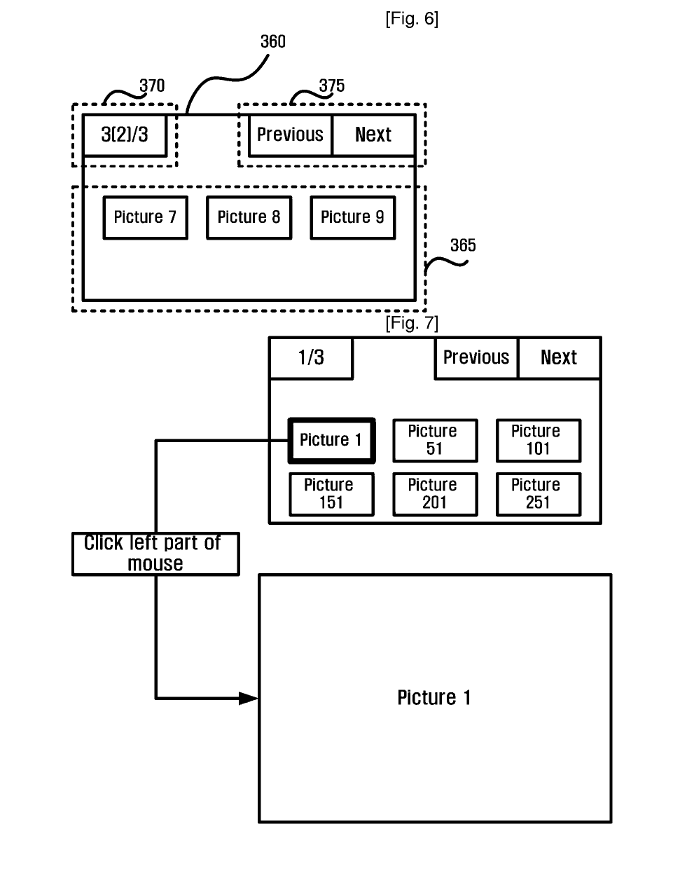

When the user selects ‘picture 1’ in FIG. 4, a user interface as in FIG. 5 appears. In this case, while thumb nail images corresponding to ‘picture 1’ to ‘picture 9’ which are included in the level-3 being the lowest level appear, ‘picture 1’ to ‘picture 6’ can be displayed in a shape as shown in FIG. 5 and ‘picture 7’ to ‘picture 9’ are displayed in a shape as shown in FIG. 6, since it is possible to see 6 thumb nail images at once at maximum in the exemplary embodiment of the present invention. At this time, ‘3(1)/3’ and ‘3(2)/3’ are displayed in the level information areas 350 and 370, respectively, wherein numbers shown in parentheses indicate the number of the pages in the corresponding lowest level, and the page control areas 355 and 357 are provided to move the pages. The reason why the level-3 is not discriminated any more is because the user may not experience any inconvenience even though he or she continuously searches for the thumb nails less than 36. That is, in the case of displaying N thumb nails, or grouping the N thumb nail images, the level is divided until the value becomes less than N square value, and the last level can be displayed as continuous pages.

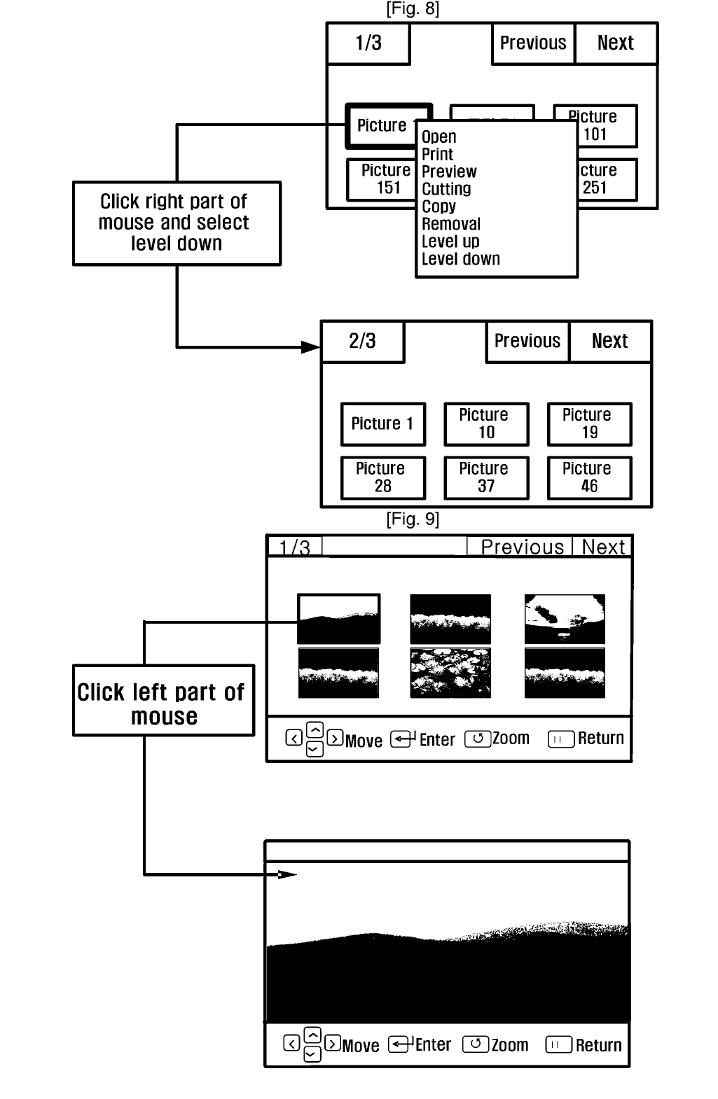

FIGS. 7 and 8 illustrate user interfaces in a personal computer environment using a mouse in accordance with an exemplary embodiment of the present invention.

In FIG. 7, it is possible to see an enlarged thumb nail image by clicking the left part of a mouse with respect to a specific thumb nail image (here, ‘picture 1’). Also, in FIG. 8, when the right part of the mouse is clicked with respect to a specific thumb nail image (here, ‘picture 1’), a menu appears, which can edit the clicked thumb nail image or move upward or downward. When the user selects a ‘level down’, thumb nail images included in the level-2 are displayed.

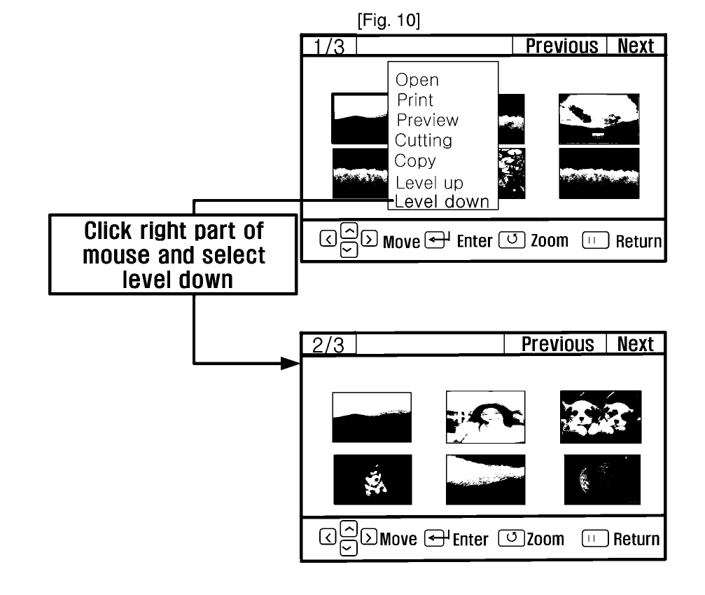

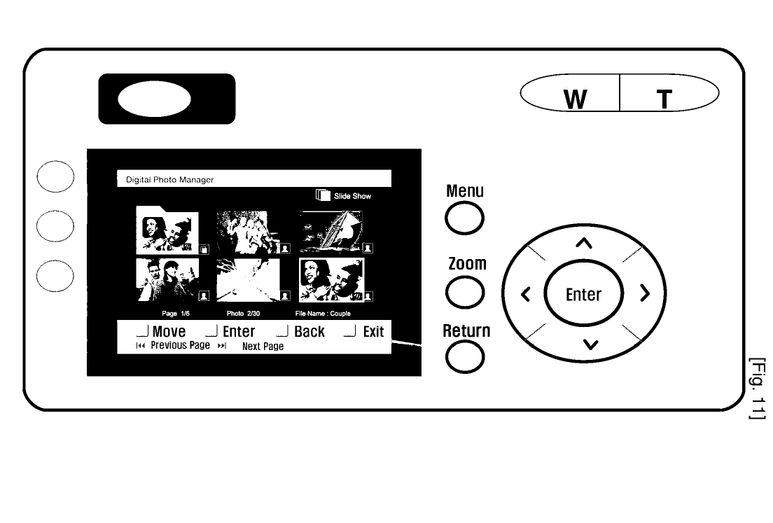

FIGS. 9 and 10 illustrate user interfaces in a personal computer environment using a mouse in accordance with another exemplary embodiment of the present invention.

FIG. 9 shows a thumb nail image enlarged by clicking the left part of the mouse as is in FIG. 7, wherein FIG. 9 includes a menu item area to process a selected thumb nail image in the lower part of the display area. For example, the menu includes a 4 direction key for changing a thumb nail image which is highlighted, an ‘Enter’ key for displaying the thumb nail image on entire screen, a ‘return’ key for moving it to a upper level, and a ‘zoom’ key for moving it to a lower level. FIG. 10 also displays a user interface including the menu item area, wherein other operation procedures using the mouse are applied in the same method as shown in FIG. 8.

FIG. 11 illustrates a user interface in a digital camera in accordance with an exemplary embodiment of the present invention. FIG. 11 shows function buttons such as zoom, return and enter on a side of a display area of the digital camera, and a menu button to display items appearing when the right part of the mouse is clicked as described in FIG. 8, and FIG. 10.

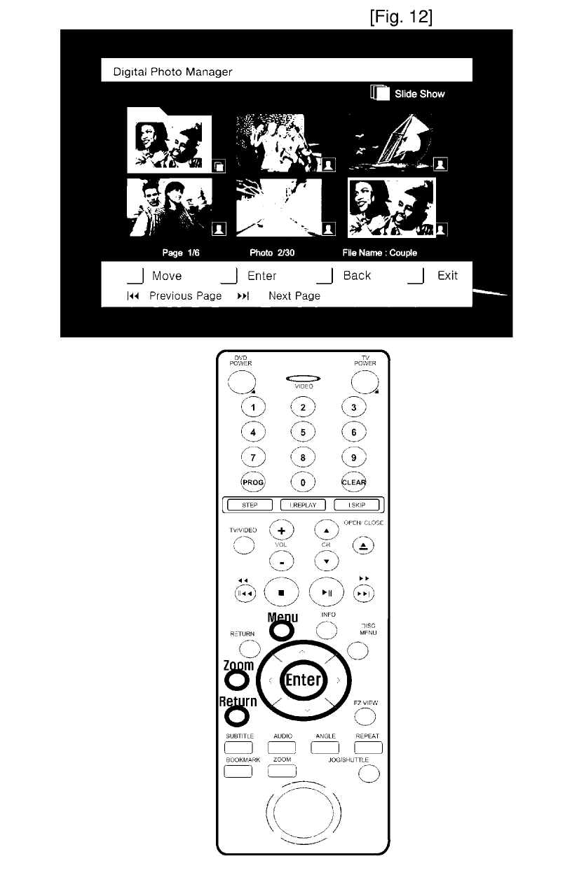

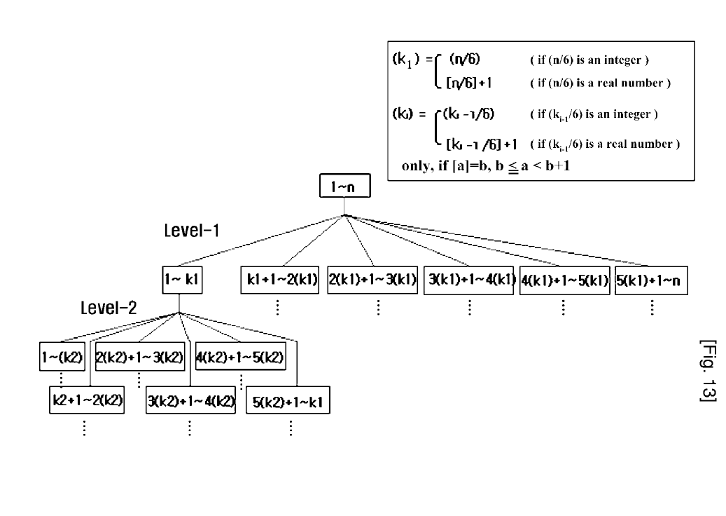

FIG. 12 illustrates a user interface in a DVD player in accordance with an exemplary embodiment of the present invention. As shown, a remote control for controlling the DVD player can include function buttons and a menu button of FIG. 11.

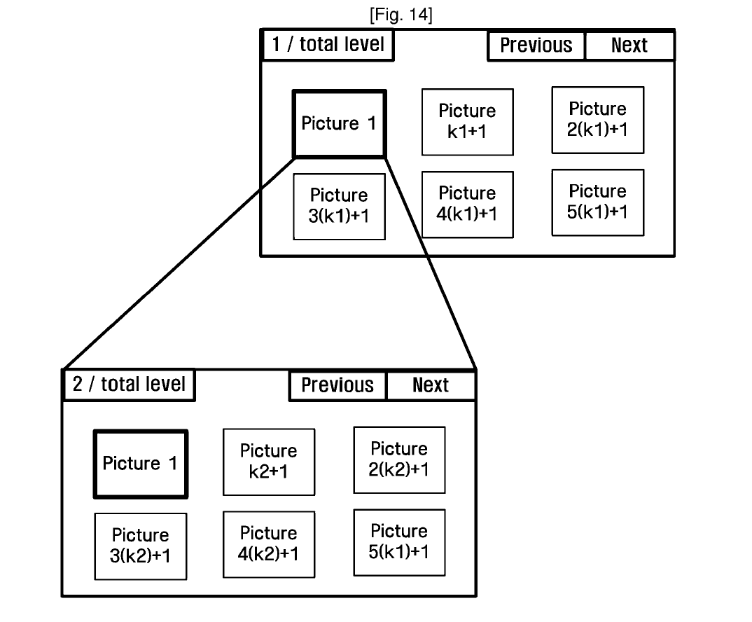

FIG. 13 illustrates a data structure of a plurality of thumb nail images in accordance with an exemplary embodiment of the present invention, and FIG. 14 illustrates thumb nail images displayed in the user interface in accordance with the data structure shown in FIG. 13.

FIG. 13 shows a tree structure, which may be produced from the assumption that 6 thumb nail images are displayed on a screen displaying thumb nail images. When there exist n thumb nail images, the images are divided into 6 groups and representative thumb nail images of each of the groups are displayed on the screen. It was explained that a collection of the representative thumb nail images of the 6 groups was called a level. Each of the groups can be displayed in the same manner by dividing them again into 6 groups, wherein a reference value that forms the group in such a method is a square of the number of thumb nail images provided by the screen. That is, when the number of thumb nail images that are subject to the grouping in an example is less than 36 being the square of 6, the grouping operation is not made any more and 6 thumb nail images per page are displayed.

On the other hand, in the case of searching for N^{th} thumb nail image among the entire thumb nail images, according to a conventional method, it is needed to confirm (N/6) pages when N/6 is an integer, and ([N/6]+1) pages when the N/6 is a real number (here, [ ] is Gaussian sign). However, according to an exemplary embodiment of the present invention, it is sufficient to confirm only 1 page at minimum to (level depth+5) pages at maximum. The level depth can be obtained by adding 1 to the number of recursive divisions of N by 6 until the quota is less or than 36. For example, when the N is 300, the level depth becomes 3.

Accordingly, the higher the value N becomes, the faster a specific thumb nail image can be searched for using a method embodied by the present invention. For example, when the number of total thumb nail images is 300 and it is needed to see 300th thumb nail image, 50 pages should be confirmed according to the conventional method, but it is sufficient to confirm only 3 pages according to the present invention.

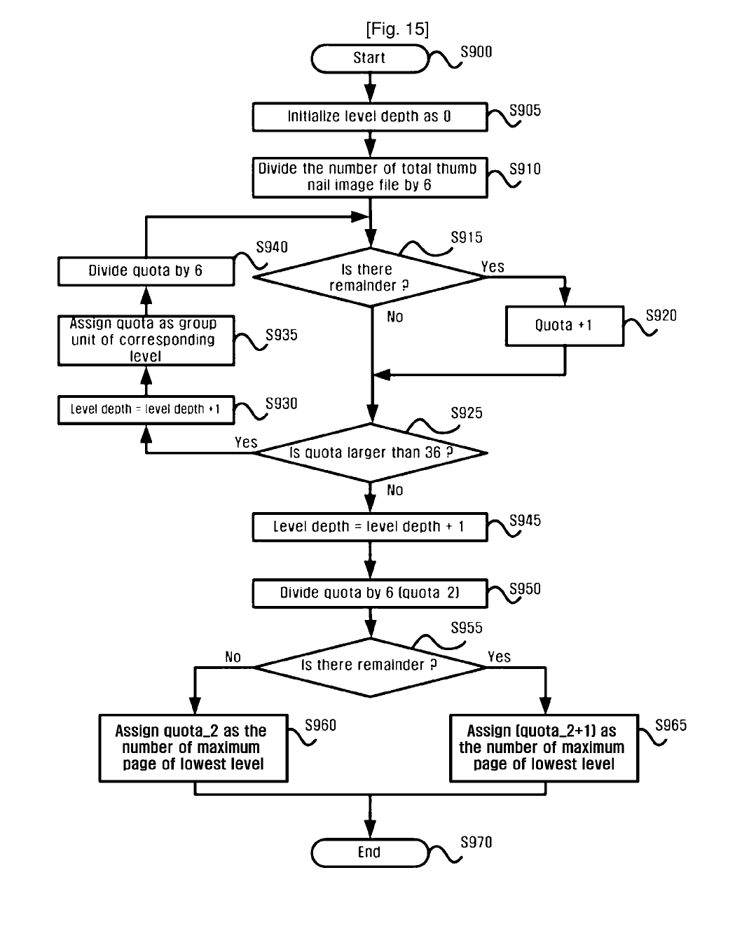

FIG. 15 is a flow chart for calculating a level depth and the number of pages in the lowest level in accordance with an exemplary embodiment of the present invention.

When the user executes an application to see a plurality of continuous thumb nail images (S900), the application converts the thumb nail images which have continuously been stored into a separate logical data structure form. At this time, the data structure is represented as a form of tree structure in an exemplary embodiment of the present invention, wherein it is needed to calculate a level depth corresponding to a depth of the tree structure and the number of the pages for displaying thumb nail image in the lowest level.

First of all, after a variable corresponding to the level depth is initialized as 0 (S905), the number of total thumb nail images is divided by 6 (S910). At this time, it is determined whether a remainder is generated or not (S915). When the remainder is generated, 1 is added to a quota calculated in step S910 (S920), and then it is determined whether the result value is larger than 36 or not (S925). When there is no remainder in step S915, it is determined whether the quota calculated in step S910 is larger than 36 or not (S925).

When the quota calculated in step S925 is larger than 36, the value of the level depth is increased by 1 (S930), and the quota is set a group unit of the corresponding level, that is, the number of the thumb nail images included in a group (S935). And then, the quota is divided by 6 (S940) and step S915 is repeatedly performed. On the other hand, when the quota is not larger than 36 in step S925, the value of the level depth is increased by 1 (S945), and the quota is divided by 6 (S950). The quota is indicated as ‘quota_2’ in FIG. 15 in order to discriminate it from the quota in step S925.

When there is no remainder in step S950, the quota_2 is assigned as the maximum page number of the lowest level (S955 and S960), and the (quota_2+1) is assigned as the maximum page number of the lowest level (S955 and S965) when there is a remainder.

As a result, the level depth is decided in step S950, and the maximum page number in the lowest level is decided in step S960 or step S965.

When the level depth and the number of the pages are calculated, the application can construct a tree structure to thumb nail images and rapidly provide a user's desired thumb nail image using the tree structure.

On the other hand, the flow chart shown in FIG. 15 illustrates a case that the number of thumb nail images which can be displayed on one screen is 6. When it is possible to display X thumb nail images on a screen, a divisor will not be 6 but X, and a determination reference of the grouping will not be 36 but a square of X.

### INDUSTRIAL APPLICABILITY

In accordance with an exemplary embodiment of the present invention, there is an effect that a user can search for a plurality of thumb nail images with more convenience and at a high speed.

Although the exemplary embodiments and drawings of the present invention have been disclosed for illustrative purposes, those skilled in the art appreciate that various substitutions, modifications, changes and additions are possible, without departing from the scope and spirit of the invention as disclosed in the accompanying claims.

1. A device for displaying image data, comprising:
(a) a display unit for displaying said image data;
(b) a control unit for dividing a plurality of said image data by a desired number to form groups of images and display representative images of each group and for displaying images of a corresponding group when a representative image is selected; and
(c) an input unit for receiving an input to navigate and select among said displayed images.

2. The device of claim 1, wherein said control unit divides images of a group including selected representative images by a desired number and regroups said divided images, and displays said representative images of said regrouped groups.

3. The device of claim 1, wherein said desired number represents the number of grouping of representative images input by a user or a predetermined number.

4. The device of claim 1, wherein said representative image is the first image generated or the last image generated among said grouped images.

5. A method of displaying image data, comprising the steps of:
(a) dividing a plurality of image data by a desired number;
(b) grouping said divided image data;
(c) selecting a representative image of each group by desired reference;
(d) displaying said representative images; and
(e) displaying images of a corresponding group when said representative image is selected.

6. The method of claim 5, further comprising the steps of:
(a) dividing said images of said corresponding group by said desired number and thereafter regrouping said divided images; and
(b) displaying representative images of said regrouped groups.

7. The method of claim 5, wherein said desired number represents the number of grouping of representative images input by a user or a predetermined number.

8. The method of claim 5, wherein said representative image is the first image generated or the last image generated among said grouped images.

9. The method of claim 5, wherein said step of displaying images of said corresponding group includes using four direction keys to navigate among said displayed images and a function means to process one image among said displayed images.

10. The method of claim 9, wherein said function means include a button for selecting one image among said displayed images.
